(19) United States
(12) Patent Application Publication
(10) Pub. No.: US 2002/0087043 A1
(43) Pub. Date: Jul. 4, 2002

(54) Device for receiving liquids to which solids have been added and device for removing liquid from such a receiving device

(76) Inventor: Gerhard Langer, Neusass (DE)

Correspondence Address: LERNER AND GREENBERG, P.A., Post Office Box 2480, Hollywood, FL, 33022-2480, US

(21) Appl. No.: 10/036,250

(22) Filed: Dec. 22, 2001

Related U.S. Application Data
(63) Continuation of application No. PCT/DE00/01187, filed on Apr. 14, 2000.

(30) Foreign Application Priority Data
Apr. 22, 1999 (DE) 199 18 334.1

(51) Int. Cl. G21F 9/00

(52) U.S. Cl. 588/1; 976/DIG. 342

(57) ABSTRACT

A device for receiving liquids to which solids have been added, in particular for receiving liquid waste from nuclear power stations, includes a body having one open end and an inner chamber. A loss plate closes off the body and has an opening formed therein. A device for removing liquid from such a receiving device includes an inner chamber, a pipe communicating with the inner chamber for leading away liquid and a cover for bearing on the receiving device. The cover has an opening formed therein in the vicinity of the inner chamber, a side facing toward the receiving device and at least one seal at the side for bearing on the loss plate.

### CROSS-REFERENCE TO RELATED APPLICATION

This application is a continuation of copending International Application No. PCT/DE00/01187, filed Apr. 14, 2000, which designated the United States.

### BACKGROUND OF THE INVENTION

### FIELD OF THE INVENTION

The present invention relates to a device for receiving liquids to which solids have been added, in particular for receiving liquid waste from nuclear power stations, including a body which is open at one end and defines an inner chamber. The invention further relates to a device for removing liquid from a receiving device, including an inner chamber, a pipe communicating with the inner chamber for leading away the liquid, and a cover for bearing on the receiving device. The cover has an opening in the vicinity of the inner chamber.

Liquid waste from a nuclear plant can be evaporated for its disposal. A process and a device suitable therefor are disclosed, for example, in German Published, Non-Prosecuted patent application DE 31 14 060 A1, corresponding to U.S. Pat. No. 4,409,137.

Such devices are used in particular in the treatment of liquid waste in nuclear power stations, which requires very stringent cleaning. The liquid waste is first centrifuged and then evaporated. That already removes a large quantity of solids which may possibly be radioactive or can impede the operation of the plant. The remaining liquid waste which is not as yet entirely clean is stored in tanks and continuously agitated. That agitation serves to avoid settling of small particles still contained in the liquid waste. Storage tanks for radioactive waste, which are also referred to as storage containers, are known, for example, from an article entitled “Entwurf von Speicherbehaltern fur hochgradig radioactive Abfallstoffe”, [Design of Storage Containers for High-Grade Radioactive Waste Material], by T. Jäger, in Kerntechnik, Vol. 3 No. 7 (1961), pages 307-312.

Such small particles are removed by in-drum drying at an underpressure or vacuum. For example, a process described in German Patent DE 42 01 841 C1 is suitable therefor. In general, the liquid waste with added solids is introduced into a drum. The drum is connected in an air-tight manner to a filler hood, with a dished head of the filler hood being placed from above onto the drum. The dished head has a dome-shape inside. An underpressure is then applied to the drum through the filler dome, so that the liquid contained therein can be evaporated and drawn off. As a result of the underpressure and the evaporation, the solids are torn from the drum in the direction of the dished head and settle there. Strong deposits form which have to be removed manually when changing the drum.

### SUMMARY OF THE INVENTION

It is accordingly an object of the invention to provide a device for receiving liquids to which solids have been added and a device for removing liquid from such a receiving device, which overcome the hereinafore-mentioned disadvantages of the heretofore-known devices of this general type and which can be used over a long period of time with minimal labor in terms of cleaning.

With the foregoing and other objects in view there is provided, in accordance with the invention, a device for receiving liquids to which solids have been added, in particular for receiving liquid waste or waste water from nuclear power stations, comprising a body having one open end and an inner chamber. A loss plate which closes off the body has an opening formed therein.

When the underpressure is applied, the loss plate is contaminated only on its side facing toward the inner chamber of the body. This contamination is reliably taken up in the body and for this reason does not have to be removed manually. Contamination of the device for removing liquid is reliably avoided.

The object of the invention is achieved in the device described above for removing liquid from a receiving device, by the fact that the cover has at least one seal on its side facing toward the receiving device, for bearing against a loss plate. This seal prevents migration of solids into an interspace between the cover and the loss plate. The cover is therefore reliably protected from contamination. Labor-intensive manual cleaning is no longer required.

In accordance with another feature of the invention, the opening is disposed at the center of the loss plate. This ensures that the inner chamber of the body is uniformly subjected to the underpressure.

In accordance with a further feature of the invention, the loss plate has a convexity. The convexity is adapted to the dome-shaped form of the known dished head and ensures reliable removal of the liquid. Moreover, due to the convexity, the loss plate can be readily elastically deformed upon contact with the cover and therefore prestressed. The seal disposed on the cover is then loaded with the prestressing force so that the sealing action is improved. Impairment of the sealing action as a result of the elastic deformation of the loss plate is excluded due to the convexity.

In accordance with an added feature of the invention, the opening in the loss plate has a peripheral thickening, in particular a rib, a web or a bead. This thickening likewise exerts a load on the seal disposed on the cover, so that the sealing action is improved. The thickening of the loss plate can be combined with the convexity.

With the objects of the invention in view, there is also provided a device for removing liquid from a receiving device, the device for removing liquid, comprising an inner chamber, a pipe communicating with the inner chamber for leading away liquid and a cover for bearing on the receiving device. The cover has an opening formed therein in the vicinity of the inner chamber, a side facing toward the receiving device and at least one seal at the side for bearing on the loss plate.

The device according to the invention for removing liquid can be used together with a receiving device having a body which is already closed off with a loss plate. Alternatively, it is possible to use a separate loss plate which is secured on the cover only when liquid is being removed from the receiving device.

In accordance with another feature of the invention, the cover has a further seal on its periphery for bearing on the receiving device. This further seal prevents penetration of the surrounding air into the receiving device and prevents the escape of solids from the receiving device.

In accordance with a further feature of the invention, the device includes a cleaning device for its inner chamber. This inner chamber communicates with the inner chamber of the receiving device through the openings in the cover and in the loss plate, and it can therefore be contaminated by solids. The cleaning device permits removal of these solids without manual assistance.

In accordance with a concomitant feature of the invention, the inner chamber of the device for removing liquid has a substantially cylindrical configuration. If the cleaning device is disposed substantially on the center axis of this cylinder, the distance from the side walls of the inner chamber remains identical at all times. This ensures a good cleaning action throughout the entire inner chamber.

Other features which are considered as characteristic for the invention are set forth in the appended claims.

Although the invention is illustrated and described herein as embodied in a device for receiving liquids to which solids have been added and a device for removing liquid from such a receiving device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, longitudinal-sectional view of a first embodiment of devices according to the invention for receiving and removing liquid;

FIG. 2 is a fragmentary, longitudinal-sectional view of a further embodiment of the devices according to the invention for receiving and removing liquid;

FIG. 3 is an enlarged view of a portion X of FIG. 2; and

FIG. 4 is an enlarged view of a portion Y of FIG. 2.

### DESCRIPTION OF THE PREFERRED EMBODIMENTS

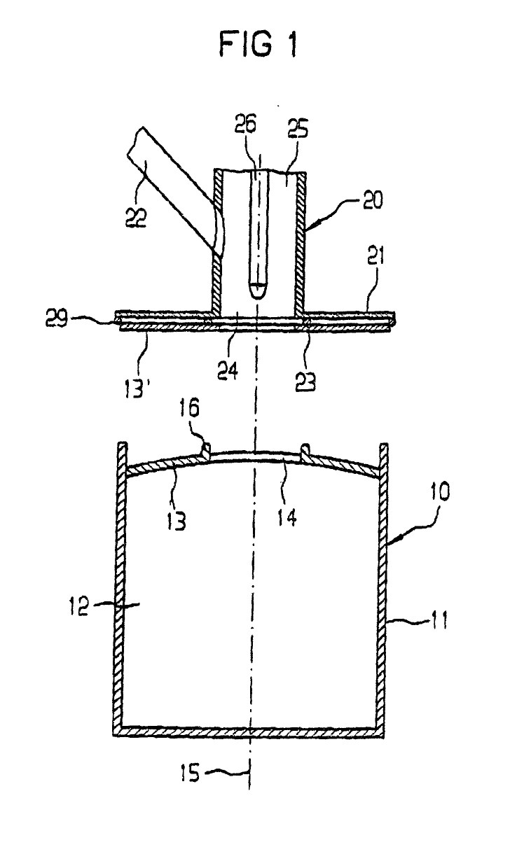

Referring now to the figures of the drawings in detail and first, particularly, to FIG. 1 thereof, there is seen a diagrammatic representation of a device, in this case a drum 10, for receiving liquids to which solids have been added. The drum 10 has a substantially cylindrical body 11 with an inner chamber 12. The body 11 is closed off by a convex loss plate 13. The loss plate 13 has an opening 14 in the vicinity of a center axis 15. The opening 14 of the loss plate 13 is surrounded by a peripheral thickening 16.

A device for removing liquid from the drum 10, which is also shown in FIG. 1, is referred to as a filler hood 20. The filler hood 20 has a cover 21 for bearing on the drum 10. An inner chamber 25, which has a substantially cylindrical configuration, is adjacent the cover 21. The cover 21 has an opening 24 in the vicinity of the inner chamber 25. An exhaust pipe 22 branches off from the inner chamber 25 and leads liquids away. A cleaning device 26 is disposed substantially centrally in the inner chamber 25 for cleaning the inner chamber 25.

The cover 21 has a seal 23 on its side facing toward the drum 10, to prevent contamination of the cover 21. In a first embodiment, this seal 23 bears on the loss plate 13 of the drum 10. In another embodiment, a loss plate 13′ can be used which is separate from the drum 10 and the filler hood 20. This loss plate 13′ is secured on the cover 21 of the filler hood 20. The drum 10 is then connected to the filler hood 20. In doing so, the loss plate 13′ is accommodated in a leak-tight manner between the cover 21 and the drum 10 at the same time. The seal 23 is provided in the vicinity of the openings 14, 24. A further seal 29 which bears on the drum 10 is disposed on the outer periphery of the cover 21.

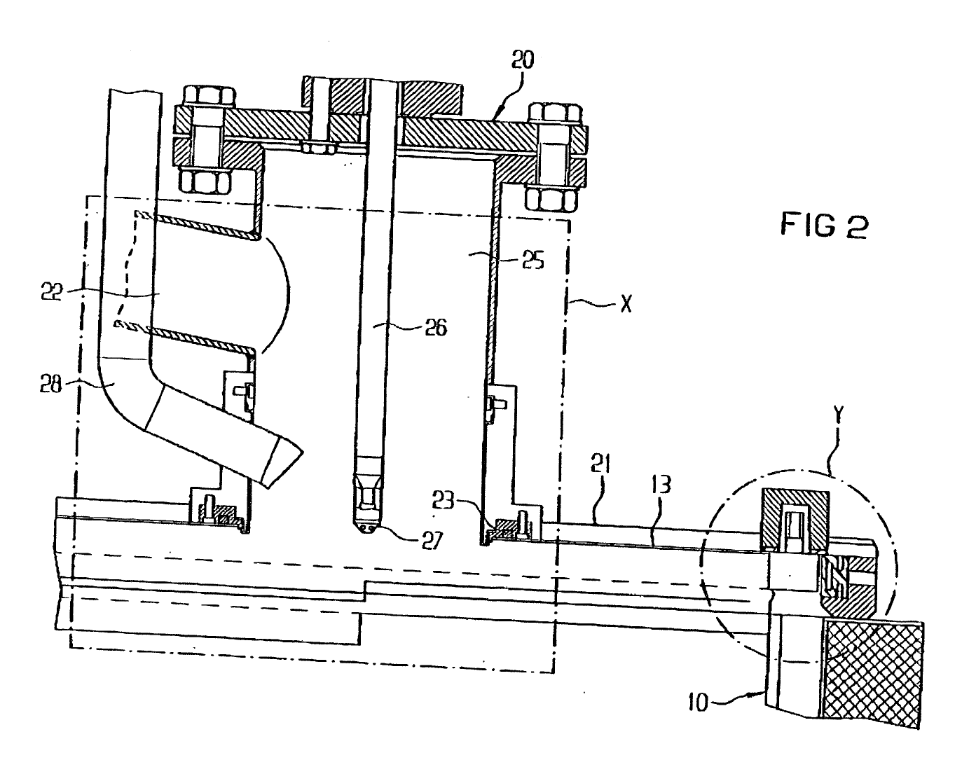

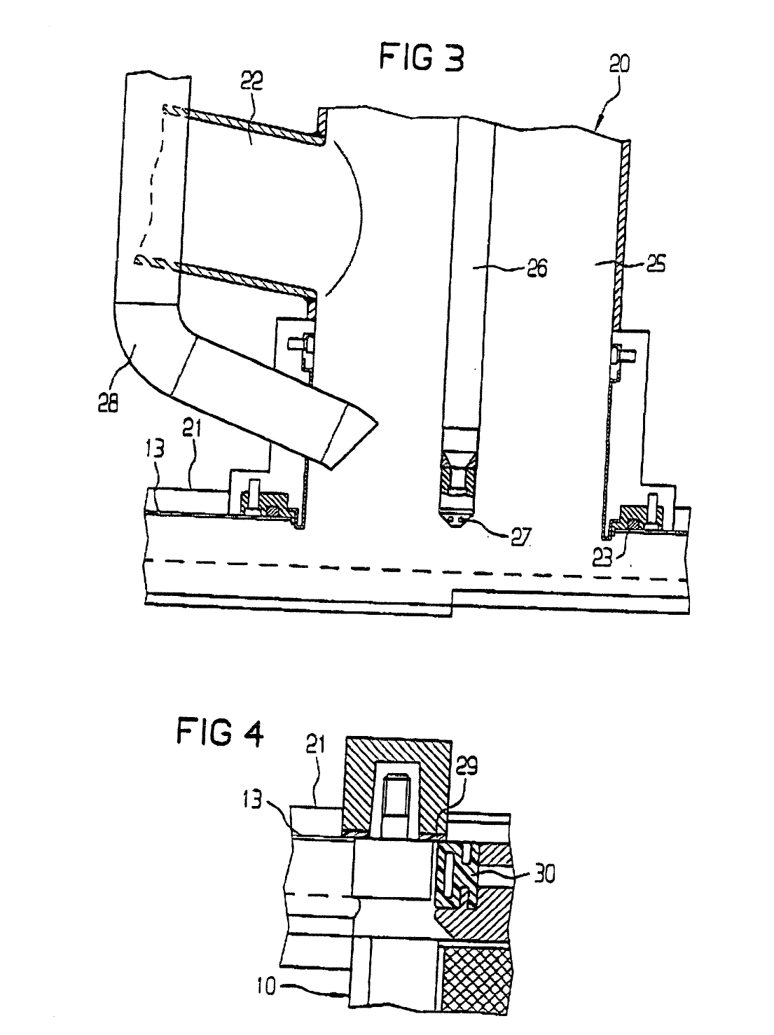

FIGS. 2 through 4 show a further embodiment of a filler hood 20 according to the invention on which a drum 10 is disposed. The loss plate 13 is accommodated between the cover 21 and the drum 10. An interspace between the loss plate 13 and the cover 21 is sealed off on the inside by the seal 23. If a loss plate 13 with a convexity is used, the cover 21 can be pressed onto the loss plate and elastically deform it. The sealing force acting on the seal 23 is greatly increased in this way.

Further seals 29, 30 are provided on the outer periphery of the loss plate 13 and of the cover 21. The seal 30 is constructed in this case as an inflatable seal and prevents penetration of surrounding air into the drum 10.

In order to remove liquid from the drum 10, an underpressure is established in the inner chamber 25 of the filler hood 20. Liquid in the drum 10 is evaporated and led away through the exhaust pipe 22. A concentrate line 28 is provided for the return of any concentrate.

Upon evaporation of the liquid, some of the solids are entrained from the drum 10. These solids settle on the loss plate 13 or in the inner chamber 25 of the filler hood 20. Penetration of the solids into the interspace between the loss plate 13 and the cover 21 is reliably avoided by the seals 23, 29, 30.

An underpressure continues to be applied and liquid removed from the drum 10. The liquid content in the drum 10 can be determined by monitoring the amount of liquid which is removed upon each application of the underpressure. When a specified liquid content is reached or when falling short of a specified liquid content, no further liquid is removed. At this point contaminants have accumulated on the side of the loss plate 13 facing toward the drum 10, and in the inner chamber 25 of the filler hood. The contaminants on the loss plate 13 are not critical since according to the invention the loss plate 13 remains on the drum 10. It is therefore not necessary to clean the loss plate 13. The drum 10 is detached together with the loss plate 13 and closed off by suitable non-illustrated measures.

In order to clean the inner chamber 25 of the filler hood 20, use is made of the cleaning device 26 which has a series of jet nozzles 27. The inner chamber 25 has a substantially cylindrical configuration. The distance between the jet nozzles 27 and the wall of the inner chamber 25 is identical over the entire length of the inner chamber. Therefore, a cleaning agent issuing from the nozzles 27 impacts at the same pressure at all points of the wall of the inner chamber 25. A reliable cleaning action is achieved in this way.

A suitable non-illustrated collecting device is advantageously applied from below onto the cover 21 for cleaning the inner chamber 25. Contamination of the environment is thus reliably avoided. Of course, the inner chamber 25 can also be cleaned with the drum 10 attached. Labor-intensive manual cleaning is no longer required.

The drum 10 according to the invention and the filler hood 20 according to the invention permit trouble-free operation over a long period of time and with minimal labor in terms of cleaning.

I claim:

1. A device for receiving liquids to which solids have been added, comprising:
a body having one open end and an inner chamber; and
a loss plate closing off said body, said loss plate having an opening formed therein.

2. The device according to claim 1, wherein said opening is centrally disposed in said loss plate.

3. The device according to claim 1, wherein said loss plate has a convexity.

4. The device according to claim 1, wherein said loss plate has a peripheral thickening at said opening.

5. The device according to claim 4, wherein said peripheral thickening is a rib.

6. The device according to claim 4, wherein said peripheral thickening is a web.

7. The device according to claim 4, wherein said peripheral thickening is a bead.

8. A device for receiving liquid waste to which solids have been added, from nuclear power stations, comprising:
a body having one open end and an inner chamber; and
a loss plate closing off said body, said loss plate having an opening formed therein.

9. A device for removing liquid from a receiving device having a body with one open end and an inner chamber, and a loss plate closing off the body and having an opening formed therein, the device for removing liquid, comprising:
an inner chamber;
a pipe communicating with said inner chamber for leading away liquid; and
a cover for bearing on the receiving device, said cover having an opening formed therein in the vicinity of said inner chamber, said cover having a side facing toward the receiving device, and said cover having at least one seal at said side for bearing on the loss plate.

10. The device according to claim 9, wherein said cover has an outer periphery and a further seal on said outer periphery for bearing on the receiving device.

11. The device according to claim 9, including a cleaning device for said inner chamber.

12. The device according to claim 9, wherein said inner chamber is substantially cylindrical.

13. A device for removing liquid from a receiving device having a loss plate, the device for removing liquid, comprising:
an inner chamber;
a pipe communicating with said inner chamber for leading away liquid; and
a cover for bearing on the receiving device, said cover having an opening formed therein in the vicinity of said inner chamber, said cover having a side facing toward the receiving device, and said cover having at least one seal at said side for bearing on the loss plate.
